(19) United States
(12) Patent Application Publication
(10) Pub. No.: US 2016/0159195 A1
(43) Pub. Date: Jun. 9, 2016

(54) HEAT DISSIPATOR AND ASSOCIATED THERMAL MANAGEMENT CIRCUIT

(71) Applicant: VALEO SYSTEMES THERMIQUES, Le Mesnil Saint Denis (FR)

(72) Inventors: Kamel Azzouz, Paris (FR); Georges De Pelsemaeker, Poigny-la-foret (FR)

(73) Assignee: Valeo Systemes Thermiques, Le Mesnil Saint Denis (FR)

(21) Appl. No.: 14/892,857

(22) PCT Filed: May 15, 2014
(86) PCT No.: PCT/EP2014/060026

§ 371 Date: Feb. 19, 2016

(30) Foreign Application Priority Data
May 22, 2013 (FR) 1354563

(51) Int. Cl. B60H 1/00

(52) U.S. Cl. CPC B60H 1/00328

(57) ABSTRACT

The present invention relates to a heat dissipator (7) for dissipating thermal energy contained in a first heat-transfer fluid and intended to be placed in a thermal management circuit (1) of a motor vehicle, said heat dissipator (7) comprising at least one inlet container (70) for the first heat-transfer fluid, at least one outlet container for the first heat-transfer fluid and heat-exchange surfaces (72) between the first heat-transfer fluid and a second heat-transfer fluid, at least one inlet container (70) and/or at least one outlet container for the first heat-transfer fluid comprising a phase change material (15).

The present invention relates to a thermal management circuit for a motor vehicle, particularly for the engine and for the passenger compartment. More particularly, the invention relates to a heat exchanger of dissipator type placed in a thermal management loop.

In the automotive field, thermal management circuits may comprise two thermal regulation loops. A first loop, called the high temperature (HT) loop, with a circulating heat-transfer fluid, having a mean high temperature of the order of 80° C. to 120° C. and a second loop, called the low temperature (BT) loop, with a circulating heat-transfer fluid, having a mean low temperature of the order of 30° C. to 80° C.

Generally speaking, a thermal regulation loop comprises two heat exchangers:
a first heat exchanger placed at the heat source in order to capture the thermal energy of the latter and to transfer it to a first heat-transfer fluid, and
a second heat exchanger serving as dissipator, releasing the thermal energy from the first heat-transfer fluid toward a second heat-transfer fluid, generally the air outside the vehicle.

In the case of a high temperature loop, the first exchanger is placed at the combustion engine and the second heat exchanger serving as dissipator is a radiator, likewise placed on the front face of the vehicle.

In the case of a low temperature loop, the first exchanger may be a charge air cooler (RAS) and/or a water condenser of an air-conditioning system. The second heat exchanger serving as dissipator, meanwhile, is placed in the air stream entering the passenger compartment of the vehicle and connected to the RAS and/or to the water condenser.

Heat dissipators are generally over-sized in order to withstand and to dissipate sufficient heat under extreme conditions in accordance with specifications imposed by automobile manufacturers. Dissipators are thus sized in order to meet theoretical maximum thermal requirements that are far in excess of that which they tackle on average and operate under so-called normal conditions at part power.

Thus, owing to these specifications, dissipators take up a great deal of space and account for a great deal of weight.

One of the objects of the invention is thus to at least in part remedy the drawbacks of the prior art and to propose an improved heat dissipator that is smaller in size but is equally as efficient.

The present invention thus relates to a heat dissipator for dissipating thermal energy contained in a first heat-transfer fluid and intended to be placed in a thermal management circuit of a motor vehicle, said heat dissipator comprising at least one inlet container for the first heat-transfer fluid, at least one outlet container for the first heat-transfer fluid and heat-exchange surfaces between the first heat-transfer fluid and a second heat-transfer fluid, at least one inlet container and/or at least one outlet container for the first heat-transfer fluid comprising a phase change material.

The use of a phase change material in a heat dissipator makes it possible to improve the efficiency thereof and allows a heat dissipator of smaller size but with an efficiency similar to that of others of larger size to be obtained.

According to one aspect of the invention, the phase change material is incorporated within the wall of at least one inlet container and/or at least one outlet container for the first heat-transfer fluid.

According to another aspect of the invention, the phase change material is in the form of capsules of phase change material (15) placed in at least one inlet container (70) and/or at least one outlet container for the first heat-transfer fluid.

The incorporation of the phase change material within the at least one inlet container and/or the at least one outlet container for the first heat-transfer fluid makes it possible to avoid an increase in the size of the heat dissipator.

According to another aspect of the invention, at least one inlet container and/or at least one outlet container for the first heat-transfer fluid comprising the capsules of phase change material comprises means for retaining said capsules of phase change material within said inlet container and/or said outlet container for the first heat-transfer fluid.

According to another aspect of the invention, the retaining means are placed at the inlets and/or outlets of the exchange surfaces and at the inlet of at least one inlet container for the first heat-transfer fluid and/or at the outlet of at least one outlet container for the first heat-transfer fluid.

According to another aspect of the invention, the means for retaining said capsules of phase change material within at least one inlet container and/or at least one outlet container for the first heat-transfer fluid are grids.

According to another aspect of the invention, the means for retaining said capsules of phase change material within at least one inlet container and/or at least one outlet container for the first heat-transfer fluid are filters.

According to another aspect of the invention, the capsules of phase change material comprise an oil-repellent and/or water-repellent surface treatment.

According to another aspect of the invention, the phase change material has a latent heat greater than or equal to 280 kJ/m³.

According to another aspect of the invention, the phase change material has a phase change temperature of between 47° C. and 55° C.

According to another aspect of the invention, the phase change material has a phase change temperature of between 80° C. and 110° C.

The present invention also relates to a thermal management circuit comprising a heat dissipator as described above, said heat dissipator being arranged in a thermal regulation loop, known as the low temperature loop, in which the heat-transfer fluid has a mean temperature of between 30° C. and 80° C.

The present invention also relates to a thermal management circuit comprising a heat dissipator as described above, said heat dissipator being arranged in a thermal regulation loop, known as the high temperature loop, in which the heat-transfer fluid has a mean temperature of between 80° C. and 120° C.

Other features and advantages of the invention will become more clearly apparent upon reading the following description, given by way of non-limiting, illustrative example, and the appended drawings, in which:

FIG. 1 shows a schematic representation of a high temperature loop,

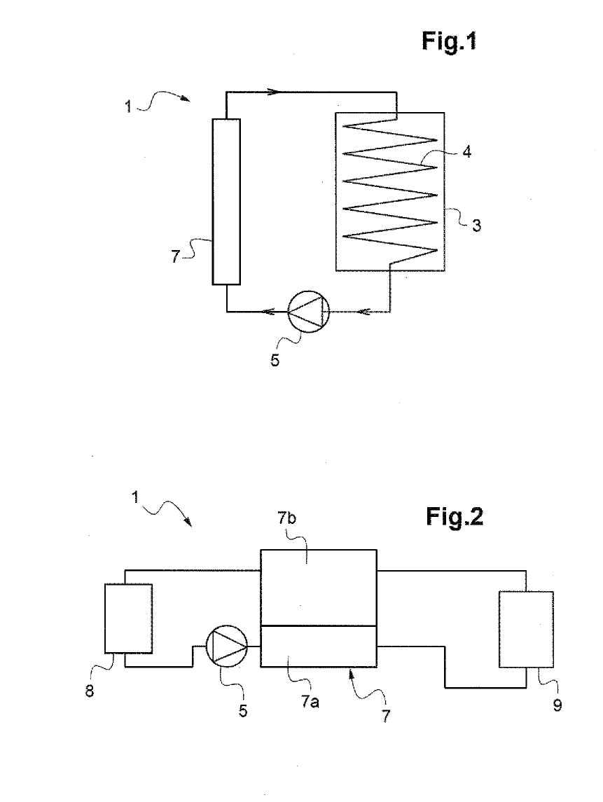

FIG. 2 shows a schematic representation of a low temperature loop,

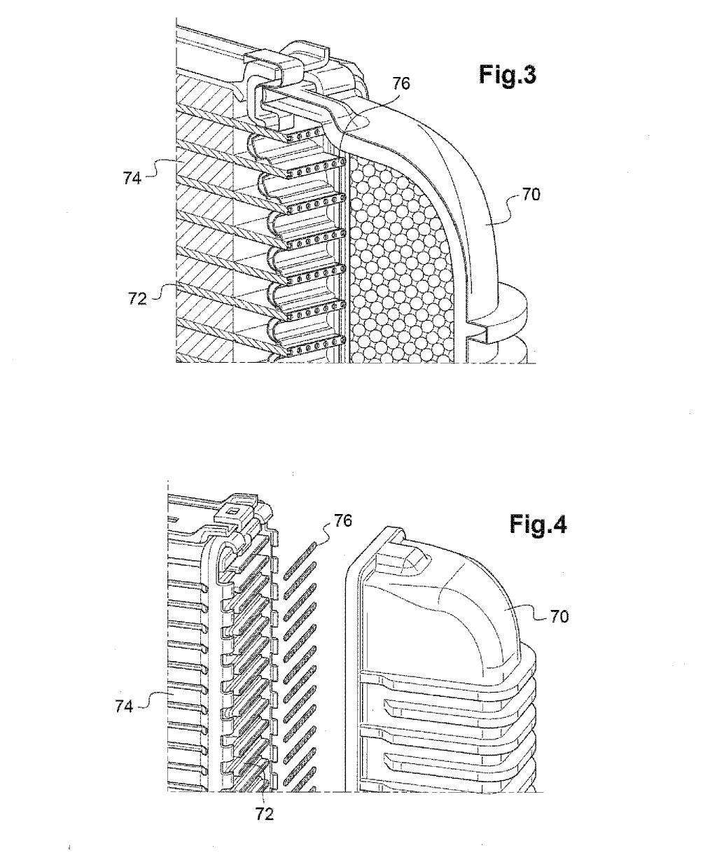

FIG. 3 shows a schematic representation, in section, of a heat dissipator,

FIG. 4 shows a schematic representation, in expanded perspective, of a heat dissipator,

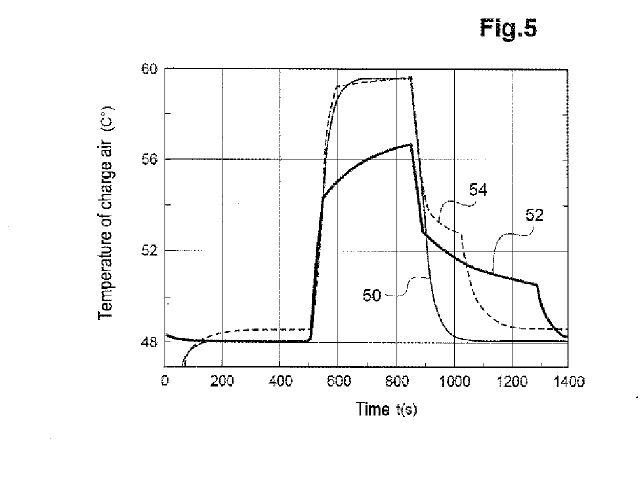

FIG. 5 shows a curve illustrating the evolution of the charge air temperature at the outlet of various types of charge air coolers.

In the various figures, identical elements bear the same reference numerals.

FIG. 1 shows a schematic representation of a first example of a thermal management circuit 1 and, more particularly, a high temperature loop.

The high temperature loop comprises a heat source, which, in this case, is the combustion engine 3, on which is installed a heat exchanger 4 capturing the thermal energy of said combustion engine 3 in order to transfer it to a first heat-transfer fluid, for example the cooling liquid. The first heat-transfer fluid circulates in the high temperature regulation loop toward a heat dissipator 7. At the heat dissipator 7, the first heat-transfer fluid transfers the thermal energy to a second heat-transfer fluid, generally the air outside the vehicle. The first heat-transfer fluid then returns toward the heat exchanger 4. A pump 5 allows circulation of the first heat-transfer fluid within the high temperature loop.

In a high temperature loop of this type, the first heat-transfer fluid may have a mean temperature of between 80° C. and 120° C.

FIG. 2 shows a schematic representation of a second example of a thermal management circuit 1 and, more particularly, a low temperature loop.

In this example of a thermal management circuit 1, the heat source may, for example, be a charge air cooler (RAS) 8 and/or a water condenser 9 connected to an air-conditioning circuit (not shown). The heat dissipator 7 may, in the case of a low temperature loop, comprise two passes 7a, 7b. The first heat-transfer fluid, which is generally glycolated water, captures the thermal energy originating from the charge air at the RAS 8, and passes at the first pass 7A of the heat dissipator 7 in order to release a portion of this thermal energy toward the second heat-transfer fluid, generally the air outside the vehicle.

The first heat-transfer fluid then passes into the water condenser 9 in order to once again exchange the thermal energy with the air-conditioning circuit (not shown). The first heat-transfer fluid passes once again at the heat dissipator 7, but at the second pass 7b, in order once again to release the thermal energy toward the second heat-transfer fluid before returning to the RAS 8. Circulation of the first heat-transfer fluid within the low temperature loop is ensured by a pump 5.

In a low temperature loop of this type, the first heat-transfer fluid may have a mean temperature of between 30° C. and 80° C.

As shown in FIGS. 3 and 4, the heat dissipator 7 also comprises at least one inlet container 70 for the first heat-transfer fluid, into which the first heat-transfer fluid arrives in order to be distributed between the heat exchange surfaces 72 between said first heat-transfer fluid and the second heat-transfer fluid. The heat dissipator 7 also comprises, at the outlet from the heat exchange surfaces 72, at least one outlet container (not shown) for the first heat-transfer fluid.

This outlet container for the first heat-transfer fluid collects the cooled fluid coming from the heat exchange surfaces 72 and guides it toward the outlet of said heat dissipator 7.

In the case of a low temperature loop, the heat dissipator 7 may comprise an inlet container 70 for the first heat-transfer fluid and an outlet container for the first heat-transfer fluid for each pass 7a, 7b.

The heat exchange surfaces 72 may, in particular, be flat tubes 72 in which the first heat-transfer fluid passes. The second heat-transfer fluid, meanwhile, circulates in the space 74 between said flat tubes 72.

The heat dissipator 7 also comprises, within its at least one inlet container 70 and/or its at least one outlet for the first heat-transfer fluid, a phase change material (MCP) 15. The MCP 15 allows absorption of thermal energy originating from the first heat-transfer fluid. This thermal energy absorbed by the MCP 15 is no longer to be dissipated by the heat dissipator 7 when there are temperature peaks and thus said heat dissipator may be of smaller size but be equally as efficient. The incorporation of the MCP 15 within the at least one inlet container 70 and/or the at least one outlet container for the first heat-transfer fluid makes it possible to avoid an increase in the size of the heat dissipator 7.

This is, in particular, shown in FIG. 5, which shows a graph illustrating the evolution of the air temperature at the outlet of an RAS 8 as a function of time and as a function of various types of heat dissipator 7. The efficiency of the heat dissipator 7 within a low temperature loop may be measured by measuring its influence on cooling of the charge air at the outlet of the RAS 8.

The first curve 50 shows the evolution, as a function of time t, of the air temperature at the outlet of an RAS 8 connected to a conventional prior art heat dissipator 7. It will be noted that there are four particular areas in the temperature curve:
A stable temperature area of t=0 s at t=500 s, where the turbocharger is not in action and where the air temperature at the outlet of the RAS 8 is constant. Under test conditions, this value is of the order of 48°. This temperature value is, of course, likely to vary as a function of exterior temperature conditions and of the temperature of intake air. Thus, under cold climatic conditions, this value may be lower.
An area of the sudden increase in temperature between t=500 s and t=600 s, which corresponds to start-up of the turbocharger, which conveys hot, compressed charge air to the RAS 8.
An area of stabilization of the charge air temperature at a value of the order of 60° C. between t=600 s and t=850 s, which corresponds to the effects of the action of the RAS 8 by dissipation of thermal energy from the charge air. This temperature value is, of course, a function of the efficiency of the low temperature loop and thus of the efficiency of the heat dissipator 7.
An area between t=850 s and t=1000 s, of a return to a stable temperature of the air temperature at the outlet of the RAS 8 identical to that of the first area, owing to the shutdown of the turbocharger.

The second curve 52, meanwhile, corresponds to the evolution of the air temperature at the outlet of an RAS 8 connected to a heat dissipator 8 of identical size to the preceding dissipator and comprising an MCP 15. With just a few differences, the same particular areas are present:
The stabilization area occurs at a lower temperature, of the order of from 54 to 57° C. owing to the action of the MCP 15, which absorbs the thermal energy and increases the efficiency of the heat dissipator 7.
The area of return to a stable temperature of the air temperature after shutdown of the turbocharger is longer and progressive, from t=850 s to t=1400 s, owing to the progressive dissipation of the thermal energy absorbed by the MCP 15.

The third curve 54 corresponds to the evolution of the air temperature at the outlet of an RAS 8 that comprises an MCP 15, but connected to a heat dissipator 7 is smaller by around 30% than the preceding dissipators. The following will thus be noted:
The stabilization area is identical to that of the first heat dissipator 7 without MCP 15 illustrated by the curve 50.
The area of return to a stable temperature of the air temperature after shutdown of the turbocharger is likewise progressive, between t=850 s and t=1100 s, owing to the progressive dissipation of the thermal energy absorbed by the MCP 15.

It is thus possible to obtain, with a heat dissipator 7 of smaller size, an efficiency similar to that of others of larger size, by virtue of the addition of an MCP 15.

The MCP 15 may, for example, be incorporated into the actual wall of the at least one inlet container and/or the at least one outlet container for charge air.

The MCP 15 may likewise be in the form of capsules of phase change material covered with a protective layer of polymeric material. This type of capsule of MCP 15 is very familiar to a person skilled in the art. The MCP 15 used may, in particular, be an extruded or polymerized MCP 15 of random form such as, for example, of spherical, hemi-spherical or amorphous form, covered with a protective layer of polymeric material. The capsules of MCP 15 preferably have a diameter of between 0.5 mm and 8 mm. Owing to the fact that the first heat-transfer fluid is a liquid, glycolated water for a low temperature loop and cooling liquid for a high temperature loop, the capsules of MCP 15 may likewise comprise an oil-repellent and/or water-repellent surface treatment to increase their oxidation resistance.

Because of the use temperature ranges in a thermal management circuit 1 of high temperature loop type, the MCP 15 used may, in particular, have a phase change temperature of between 80° C. and 110° C. Similarly, in a thermal management circuit 1 of low temperature loop type, the MCP 15 used may, in particular, have a phase change temperature of between 47° C. and 55° C.

Furthermore, the MCP 15 used may, advantageously, have a latent heat greater than or equal to 280 kJ/m³ in order to offer optimum efficiency.

If the MCP 15 is in the form of capsules, as illustrated by FIGS. 3 and 4, the at least one inlet container 70 and/or the at least one outlet container for charge air comprising the capsules of MCP 15 comprises means 76 for retaining said capsules of MCP 15 within said inlet container 70 and/or said outlet container for charge air.

The retaining means 76 are preferably placed at the inlets and/or outlets of the exchange surfaces 72 in order that the capsules of MCP 15 do not enter between these latter and do not block or impede the charge air stream. The retaining means 76 are likewise placed at the inlet of the at least one inlet container 70 for charge air and/or at the outlet of the at least one outlet container for charge air so that the capsules do not escape into the conduit between the RAS 8 and the turbocharger 3 or toward the combustion cylinders 5.

The retaining means 76 may, for example, be grids having a mesh smaller than the diameter of the capsules of MCP 15 or, alternatively, be filters of the porous diffuser type.

At the inlets and/or outlets of the exchange surfaces 72, the retaining means 76 may, according to a first embodiment shown in FIG. 3, cover the total surface between the at least one inlet container 70 and/or the at least one outlet container for charge air with the exchange surfaces 72. According to a second embodiment, shown in FIG. 4, the retaining means 76 cover only the spaces 73 in which the charge air circulates.

It can thus readily be seen that the heat dissipator 7 according to the invention allows improved cooling of the charge air owing to the presence of phase change material 15 within. The heat dissipator 7 according to the invention, which is equally as efficient as a conventional heat dissipator 7, may thus be smaller in size.

1. A heat dissipator for dissipating thermal energy contained in a first heat-transfer fluid and intended to be placed in a thermal management circuit of a motor vehicle, said heat dissipator comprising:
at least one inlet container for the first heat-transfer fluid; and
at least one outlet container for the first heat-transfer fluid and heat-exchange surfaces between the first heat-transfer fluid and a second heat-transfer fluid,
wherein at least one inlet container and/or at least one outlet container for the first heat-transfer fluid comprises a phase change material.

2. The heat dissipator as claimed in claim 1, wherein the phase change material is incorporated within the wall of at least one inlet container and/or at least one outlet container for the first heat-transfer fluid.

3. The heat dissipator as claimed in claim 1, wherein the phase change material is in the form of capsules of phase change material placed in at least one inlet container and/or at least one outlet container for the first heat-transfer fluid.

4. The heat dissipator as claimed in claim 3, wherein at least one inlet container and/or at least one outlet container for the first heat-transfer fluid comprising the capsules of phase change material comprises means for retaining said capsules of phase change material within said inlet container and/or said outlet container for the first heat-transfer fluid.

5. The heat dissipator as claimed in claim 4, wherein the retaining means are placed at the inlets and/or outlets of the exchange surfaces and at the inlet of at least one inlet container for the first heat-transfer fluid and/or at the outlet of at least one outlet container for the first heat-transfer fluid.

6. The heat dissipator as claimed in claim 4, wherein the means for retaining said capsules of phase change material within at least one inlet container and/or at least one outlet container for the first heat-transfer fluid are grids.

7. The heat dissipator as claimed in claim 4, wherein the means for retaining said capsules of phase change material within at least one inlet container and/or at least one outlet container for the first heat-transfer fluid are filters.

8. The heat dissipator as claimed in claim 3, wherein the capsules of phase change material comprise an oil-repellent and/or water-repellent surface treatment.

9. The heat dissipator as claimed in claim 1, wherein the phase change material has a latent heat greater than or equal to 280 kJ/m³.

10. The heat dissipator as claimed in claim 9, wherein the phase change material has a phase change temperature of between 47° C. and 55° C.

11. The heat dissipator as claimed in claim 1, wherein the phase change material has a phase change temperature of between 80° C. and 110° C.

12. A thermal management circuit comprising a heat dissipator as claimed in claim 1, said heat dissipator being arranged in a thermal regulation loop, known as a low temperature loop, in which the first heat-transfer fluid has a mean temperature of between 30° C. and 80° C.

13. A thermal management circuit comprising a heat dissipator as claimed in claim 1, said heat dissipator being arranged in a thermal regulation loop, known as a high temperature loop, in which the first heat-transfer fluid has a mean temperature of between 80° C. and 120° C.
